(19) United States
(12) Patent Application Publication
(10) Pub. No.: US 2020/0045350 A1
(43) Pub. Date: Feb. 6, 2020

(54) PREFETCHING VIDEO SEGMENTS TO REDUCE PLAYBACK STARTUP DELAY

(71) Applicant: SLING MEDIA PVT LTD, Bengaluru (IN)

(72) Inventors: AISHWARYA HEGDE, Bengaluru (IN); JAYACHANDRAKUMAR KONDURU, Bengaluru (IN)

(73) Assignee: SLING MEDIA PVT LTD, Bengaluru (IN)

(21) Appl. No.: 16/052,260

(22) Filed: Aug. 1, 2018

(51) Int. Cl. H04N 21/2387; H04N 21/2343; H04N 21/231

(52) U.S. Cl. CPC H04N 21/2387; H04N 21/234309; H04N 21/23106; H04N 21/234363; H04N 21/234345

(57) ABSTRACT

A method of processing and delivering video content is disclosed. An embodiment of the method maintains a raw version of a video program at a server system. Before receiving any request to stream the video program from the server to a client device, a prefetching routine is performed on the video program to transcode and segments a leading portion of the video program. Before receiving any request to stream the video program from the server to the client device, the prefetched video segments are stored in cache memory of the server. The server receives a request to stream the video program to the client device. In response to the request, the prefetched video segments are streamed from the cache memory. The prefetching routine is also performed on the video program to transcode and segment a future portion of the video program, resulting in additional prefetched video segments.

### TECHNICAL FIELD

Embodiments of the subject matter described herein relate generally to video delivery systems and related operating methodologies. More particularly, embodiments of the subject matter relate to techniques and technologies intended to reduce playback startup latency in a streaming video system.

### BACKGROUND

The prior art is replete with systems, techniques, and methodologies related to the streaming of video content over a communication network to a user device or system, such as a mobile device, a computer system, a web-enabled appliance, or the like. In accordance with a common methodology, a cloud-based server system receives an original version of a video program (in digital format), transcodes the video data on demand into a format suitable for transport over a network (such as the Internet), and streams the transcoded video data as video segments to the user's remote device.

Playback of streaming video content begins a brief time after the user initiates playback. The amount of delay can be influenced by various factors, such as: the available network bandwidth; the transcoding resources and processing power available at the server system; the memory and storage capacity at the server system; and certain operating specifications and characteristics of the client presentation device. The time delay associated with the startup of place-shifted video content can be lengthy and bothersome under most operating conditions.

Accordingly, it is desirable to have a techniques and technologies that can reduce the startup latency of streaming video content. Furthermore, other desirable features and characteristics will become apparent from the subsequent detailed description and the appended claims, taken in conjunction with the accompanying drawings and the foregoing technical field and background.

### BRIEF SUMMARY

A method of processing and delivering video content is disclosed here. An embodiment of the method maintains, at a computer-based server system, a raw version of a video program. Before receiving any request to stream the video program from the server system to a client presentation device, a prefetching routine is performed on the raw version of the video program, wherein the prefetching routine transcodes and segments a leading portion of the raw version of the video program, resulting in prefetched video segments. Before receiving any request to stream the video program from the server system to the client presentation device, the prefetched video segments are stored in cache memory of the server system. The method continues by receiving, at the server system, a request to stream the video program from the server system to the client presentation device and, in response to receiving the request, streaming the prefetched video segments from the cache memory. The prefetching routine is also performed on the raw version of the video program to transcode and segment a future portion of the raw version of the video program, resulting in additional prefetched video segments.

A computer-implemented server system is also disclosed here. An embodiment of the server system includes a processor device and a non-transitory computer readable medium operatively associated with the processor device. The computer readable medium includes executable instructions configurable to cause the processor device to perform a method of processing and delivering video content, the method including the steps of: maintaining, at the server system, a raw version of a video program; before receiving any request to stream the video program from the server system to a client presentation device, performing a prefetching routine on the raw version of the video program, wherein the prefetching routine transcodes and segments a leading portion of the raw version of the video program, resulting in prefetched video segments; before receiving any request to stream the video program from the server system to the client presentation device, storing the prefetched video segments in cache memory of the server system; receiving, at the server system, a request to stream the video program from the server system to the client presentation device; in response to receiving the request, streaming the prefetched video segments from the cache memory; and in response to receiving the request, performing the prefetching routine on the raw version of the video program to transcode and segment a future portion of the raw version of the video program, resulting in additional prefetched video segments.

Another embodiment of the server system includes a processor device and a non-transitory computer readable medium operatively associated with the processor device, the computer readable medium having executable instructions configurable to cause the processor device to perform a method of processing and delivering video content, the method including the steps of: maintaining, in cache memory of the server system, sets of prefetched video segments that have been transcoded and segmented from a leading portion of a video program, each set of prefetched video segments associated with a different combination of display resolution and video file format; receiving, at the server system, a request to stream the video program from the server system to a client presentation device; in response to receiving the request, selecting only one of the sets of prefetched video segments; streaming the selected set of prefetched video segments from the cache memory; and in response to receiving the request, performing a prefetching routine on the video program to transcode and segment a future portion of the video program, resulting in additional prefetched video segments.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram that illustrates an exemplary embodiment of a streaming video system;

FIG. 2 is a flow chart that illustrates an exemplary embodiment of a video prefetching process;

FIG. 3 is a flow chart that illustrates an exemplary embodiment of a video streaming process; and

FIG. 4 is a block diagram that illustrates an exemplary embodiment of a computer-implemented device or system suitable for use with the streaming video system depicted in FIG. 1.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like. The software that performs the described functionality may reside and execute at a host device, such as a video services receiver, a mobile device, or a home entertainment component, or it may be distributed for execution across a plurality of physically distinct devices, systems, or components, as appropriate for the particular embodiment.

The following description relates to a video delivery system that is suitably configured to process audio/visual content for presentation to a user. Although the following description focuses on video content (e.g., video programs, movies, recorded television shows, etc.), the subject matter may also be utilized to handle audio content conveyed in an audio stream, such as a broadcast radio program, a streaming music channel, or the like.

The exemplary embodiments described below relate to a system and related methodology that reduces the startup latency associated with the delivery of a stream of video data to a client presentation device. Although not always required, in certain embodiments the disclosed methodology reduces the startup latency of video content that originates at a hypertext transport protocol (HTTP) server system that transcodes the original video data into video segments and communicates the video segments to the presentation device via a data communication network such as the Internet. In accordance with the exemplary embodiments described here, the original version of a video program is processed soon after it is initially uploaded to the server system. The processing of the original/raw version of the video program includes the generation of the first ten (or any desired number) video segments in advance and storing the segments in cache memory. This “prefetching” routine is performed on the newly uploaded video program, preferably before the server system receives any client request to stream the video program. Thereafter, when a client device initiates streaming of the video program, the prefetched video segments can be immediately streamed from the cache memory. As described in more detail below, the prefetching routine can be extended to generate multiple sets of video segments, wherein each set corresponds to a different display resolution and/or a different type of video segment file format.

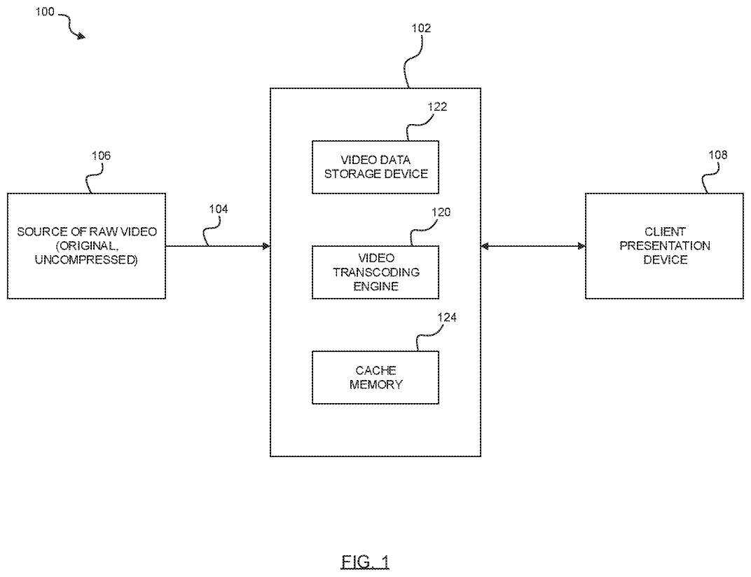

Referring to the drawings, FIG. 1 is a block diagram that illustrates an exemplary embodiment of a streaming video system 100, which is configured to provide streaming media content to a remote client presentation device. The system 100 can be utilized to carry out web-based delivery of video content. The illustrated embodiment of the system 100 includes a computer-based server system 102 (e.g., an HTTP compatible web server) that receives an original or raw digital version of a video program 104 from a media source 106, transcodes the received video program 104 into a streaming format that includes a plurality of video segments, and transmits the transcoded video segments 104 to a client presentation device 108 over a data communication network. The client presentation device 108 receives a stream of transcoded video segments, decodes the stream, and presents the decoded content to a viewer on a display element associated with the client presentation device 108.

The server system 102 is any component, hardware, software logic, etc., or any combination thereof, which is capable of processing video data for purposes of transmitting a packetized stream of video segments over a network to the client presentation device 108. For example, the server system 102 may be realized as any of the following, without limitation: a physically distinct piece of computer hardware (e.g., a web server component); a video services receiver (e.g., a set-top box) that serves video content; web-enabled television equipment; a web-enabled appliance; a piece of audio/video equipment; or the like. In various embodiments, the server system 102 incorporates suitable encoder and/or transcoder logic in the form of a transcoding engine 120. Regardless of its form factor and hardware platform, the server system 102 is suitably configured to support the desired features and functions using the appropriate hardware, software, firmware, etc. For example, the server system 102 may include, without limitation: an input module or interface to receive the raw version of the video program 104 from the media source 106; at least one storage device 122 that can store data (including raw video program data, transcoded video segments, and other data as needed to support the features and functions described herein); and an appropriate amount of cache memory 124.

The client presentation device 108 is any device, component, module, hardware, software, etc., or any combination thereof, which is capable of receiving a stream of transcoded video segments from the server system 102. In various embodiments, the client presentation device may be, without limitation: a personal computer (e.g., a laptop, desktop, tablet, or other form factor); a mobile phone; a personal digital assistant; a personal media player; a wearable computing device; a video game console or device; a smart home appliance; a smart television; or the like. In many embodiments, the client presentation device 108 is a general purpose computing device that includes a media player application in software or firmware that is capable of securely connecting to the server system 102, and is capable of receiving and presenting media content to the user of the device as appropriate. In other embodiments, however, the client presentation device 108 is a standalone or other separate hardware device capable of receiving and decoding a stream of video segments to provide an output signal that is presented on an associated display.

For the sake of clarity and simplicity, FIG. 1 does not show any network infrastructure. Nonetheless, it should be understood that any suitably configured network arrangement can be utilized to support data communication between the various components and elements shown in FIG. 1. Such data communication may take place over a wide area link that includes the Internet and/or a telephone network, for example; in other embodiments, communications between the server system 102 and the client presentation device 108 may take place over one or more wired or wireless local area links. In various equivalent embodiments, the server system 102 and the client presentation device 108 may be directly connected via any sort of cable (e.g., an Ethernet cable or the like) with little or no other network functionality provided.

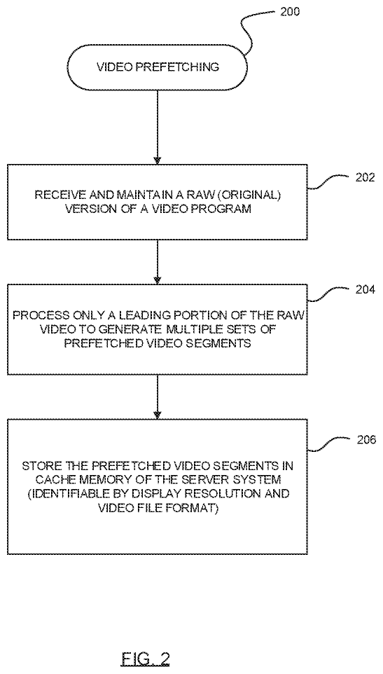

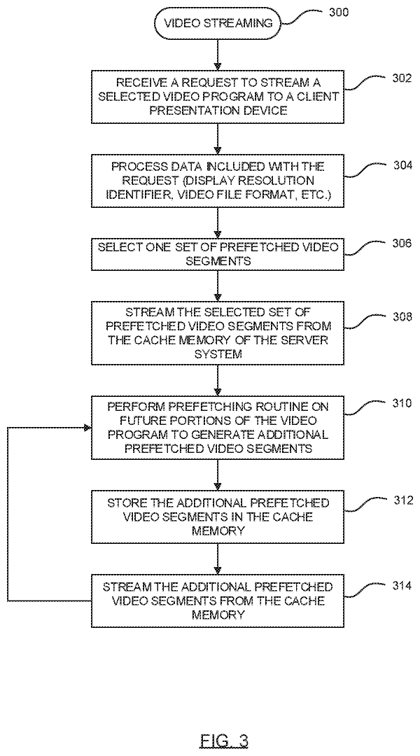

FIG. 2 is a flow chart that illustrates an exemplary embodiment of a video prefetching process 200, and FIG. 3 is a flow chart that illustrates an exemplary embodiment of a video streaming process 300. The various tasks performed in connection with an illustrated process may be performed by software, hardware, firmware, or any combination thereof. It should be appreciated that an illustrated process may include any number of additional or alternative tasks, the tasks shown in the figures need not be performed in the illustrated order, and a described process may be incorporated into a more comprehensive procedure or process having additional functionality not described in detail herein. Moreover, one or more of the tasks shown in a figure could be omitted from an embodiment of the described process as long as the intended overall functionality remains intact.

Referring to FIG. 2, the video prefetching process 200 represents an aspect of an exemplary embodiment of a method of processing and delivering video content. For the implementation described here, the process 200 is performed by a computer-based HTTP server system that is designed and configured to support streaming of video segments to client presentation devices via a network such as the Internet. Although not always required, this example assumes that the process 200 is performed by the server system in response to an initial upload of video content (e.g., a digital file that represents an original or raw version of a video program intended for streaming delivery), and before receiving and servicing any request to stream the video program to a client presentation device. Accordingly, the process 200 can be considered to be a background process performed by the server system to prepare the uploaded video program for subsequent streaming requests.

The illustrated embodiment of the process 200 begins by receiving and maintaining a raw or original version of a video program (task 202). As used herein, the “raw” or “original” version is a digital representation of the video program that has been encoded into a particular format by an input source such as a mobile device, a video recorder, or any other related device, and then uploaded to the server. In preferred implementations, the raw/original version is received in the highest available display resolution, which allows the server system to downscale the resolution if so desired.

In certain embodiments, the server system receives the video program file over a data communication network from an appropriate source, such as the source 106 shown in FIG. 1. In some scenarios, however, the server system can receive the video program file in a more direct manner, such as a removable storage device, a direct (point-to-point) wireless link to a source device, a local area network, or the like. These and other uploading mechanisms are contemplated by this disclosure. Once uploaded/received, the original video program file is stored and maintained in a memory storage device that is integrated with, coupled to, or otherwise associated with the server system. For example, the original video program file can be maintained in the storage device 122 depicted in FIG. 1. Maintaining video program files in server memory allows the server system to process and transcode the video data on demand.

Before receiving any request to stream the video program from the server system to a client presentation device, the process 200 performs a prefetching routine on the uploaded video to transcode and segment at least some of the original video data. For the exemplary embodiment described here, the process 200 transcodes and segments only a leading portion of the raw version of the video program, which results in prefetched video segments (task 204). In this regard, only a limited number of initial video segments are generated by task 204, such as the first ten segments of the video program (in practice, more or less than ten initial video segments can be generated at task 204). Limiting the number of prefetched video segments is desirable in certain implementations having limited processing resources and/or limited storage space.

In preferred embodiments, the prefetching routine is performed to create multiple sets (different versions) of prefetched video segments. Each set is associated with a different display resolution and/or is associated with a different video file format. For this particular example, each video segment set is associated with a different combination of display resolution and video file format. Multiple versions are generated by the server system so that the leading video segments need not be created on demand when a client device requests streaming of the video program. This results in less delay and better performance from the perspective of the viewer.

Task 204 can generate prefetched video segments having any number of different resolutions. Although not always required, the example presented here generates video segments having five common display resolutions: 1080p, 720p, 480p, 360p, and 240p. Alternative and/or additional display resolutions can be supported if so desired. Task 204 can generate prefetched video segments having any supported video file format. Although not always required, the example presented here generates video segments as either Transport Stream (.ts) files or as Dynamic Adaptive Streaming over HTTP (DASH) segment files (.m4s files). Alternative and/or additional video file formats can be supported if so desired. For the embodiment described here, task 204 creates ten sets of prefetched video segments corresponding to the same leading portion of the video program—each set is identifiable by one of the five available display resolutions, and by one of the two available video file formats.

Before receiving any request to stream the video program from the server system to a client presentation device, the process 200 stores the prefetched video segments in cache memory of the server system (task 206). More specifically, the different sets of prefetched video segments are stored and maintained in the cache memory, such that they are identifiable by their respective display resolution and video file format. Ideally, the sets of prefetched video segments remain in the cache memory and, going forward, can be immediately streamed from the cache memory on demand. Thus, the video prefetching process 200 need not be repeated whenever a client presentation device initiates streaming of the video program. Instead, the process 200 can be performed once for each uploaded video program (and repeated only as needed for maintenance, to fix corrupted files, etc.).

Referring to FIG. 3, the video streaming process 300 represents an aspect of an exemplary embodiment of a method of processing and delivering video content. For the implementation described here, the process 300 is performed by a computer-based HTTP server system (e.g., the server system 102) that is designed and configured to support streaming of video segments to client presentation devices via a network such as the Internet. Although not always required, this example assumes that the process 300 is performed after the video program of interest has been treated by the prefetching process 200. Accordingly, this description assumes that multiple sets of prefetched video segments have already been generated and stored in the cache memory of the server system.

The following description of the process 300 assumes that a network communication link has already been established between the server system and a client presentation device (i.e., the end user device that will play the streaming video program). Thus, the process 300 begins by receiving (at the server system) a request, instruction, or command to stream an identified video program from the server system to the requesting client presentation device (task 302). The request can be initiated at the client presentation device in response to the user selecting new video content for playback, changing “channels” of available video content, or the like. The request may include information needed to enable the server system to take appropriate action. For example, the request may: identify the client presentation device (by a device address, an network address, or other identifier); identify the video program to be streamed; include a display resolution identifier or other data, which can be used to determine which set of prefetched video segments to stream; include a measure of available network bandwidth, which can be used to determine which set of prefetched video segments to stream; include data that describes certain characteristics of the client presentation device (e.g., device configuration data, compatibility data, video playback capabilities, native display resolution, and the like), which can be used to determine which set of prefetched video segments to stream; and/or include other information that can be used by the server system to select the appropriate set of cached video segments.

The video streaming process 300 continues by processing the request, data included with the request, and/or previously saved data that is linked to the requesting client presentation device (task 304). The server system processes the request as needed to select one of the cached sets of prefetched video segments (task 306). For the exemplary embodiment described here, task 306 selects the set of video segments based on a received (or already known) display resolution identifier and based on a received (or already known) video file format supported by the requesting client presentation device. As mentioned previously, the display resolution identifier and the video file format can be conveyed in the request itself. In other scenarios, the server system may have prior knowledge of the desired video file format, the desired display resolution, and/or other characteristics of the requesting client presentation device based on analytics data obtained from previous playback history. The information contained in the request and/or other information or data linked to the requesting client device enables the server system to quickly and intelligently select one (and only one) set of prefetched video segments. In practice, the selecting performed at task 306 is influenced by both the display resolution identifier and the video file format associated with the requesting client presentation device.

The process 300 continues by streaming the selected set of video segments from the cache memory of the server system to the requesting client presentation device (task 308). As explained above, streaming can begin rather quickly and with reduced startup latency because the video segments have already been transcoded and cached. In accordance with the exemplary embodiment, only the first ten video segments of the requested video program are maintained in the cache memory. Therefore, the remaining portion of the video program (referred to herein as the “future portion” to distinguish it from the prefetched portion) must be transcoded in an ongoing manner to support the video stream. To this end, the process 300 performs the prefetching routine on the raw version of the video program to transcode and segment a future portion of the video program (task 310).

Task 310 results in the generation of additional prefetched video segments, which are resident at the server system. These additional prefetched video segments are stored in the cache memory as they become available (task 312). It should be appreciated that task 310 and task 312 are preferably executed in an ongoing manner during the streaming of the first ten prefetched video segments from the cache memory. Thus, the cache memory is replenished with newly created video segments before those segments are actually needed. Eventually, the additional prefetched video segments are streamed from the cache memory to the requesting client presentation device (task 314). As schematically depicted in FIG. 3, after the initially prefetched video segments have been streamed, tasks 310, 312, and 314 are repeated as needed such that future portions of the raw video program are transcoded, segmented, and cached before they are actually streamed. Consequently, prefetching the leading portion of the video program results in less startup latency, and enables the server system to transcode the remaining video content in an ongoing manner without adversely impacting the end user experience.

Notably, the process 300 need not (and preferably does not) transcode the future portions of the video program into different versions to support different display resolutions and/or different video file formats. Instead, the prefetching routine can be performed to transcode and segment the future portions of the video program in accordance with only one display resolution and in accordance with only one video file format (namely, the display resolution and video file format associated with the selected set of initial video segments). Simply put, tasks 310, 312, and 314 can be performed efficiently to accommodate the current needs of the requesting client presentation device. In practice, the video file format will remain unchanged during streaming of the entire video program, but the display resolution may vary based on the available client bandwidth. Assuming that the client bandwidth does not fluctuate, then under most circumstances, the display resolution and video file format will remain unchanged during streaming of the entire video program.

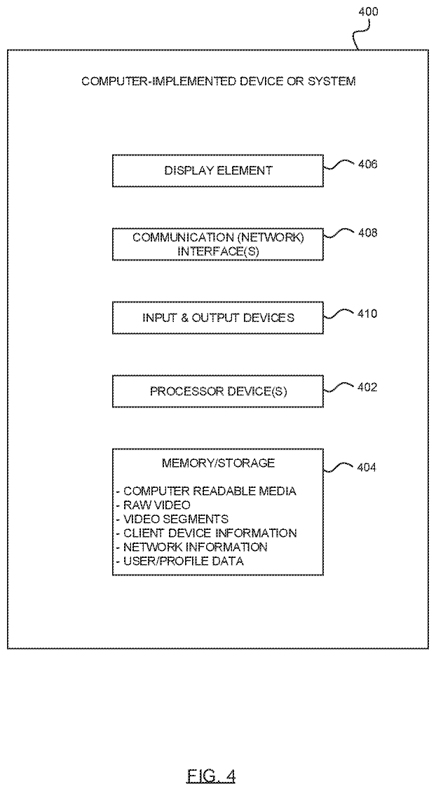

The server system and the client presentation device described herein can be realized as (or can be integrated with) a computer-implemented component. In this regard, FIG. 4 is a simplified block diagram representation of an exemplary embodiment of a computer-implemented system or device 400 that is suitable for use with the streaming video system 100 depicted in FIG. 1. The illustrated embodiment of the device 400 generally includes, without limitation: at least one processor device 402; at least one memory/storage device 404; a display element 406; at least one communication (network) interface 408; and input and output (I/O) devices 410. In practice, the device 400 can include additional components, elements, and functionality that may be conventional in nature or unrelated to the particular video streaming and media playback functionality described here.

A processor device 402 may be, for example, a central processing unit (CPU), a field programmable gate array (FPGA), a microcontroller, an application specific integrated circuit (ASIC), or any other logic device or combination thereof. The memory/storage device 404 is communicatively coupled to the processor device 402, and it can be implemented with any combination of volatile and non-volatile memory. The memory/storage device 404 has non-transitory computer readable and executable instructions (program code) stored thereon, wherein the instructions are configurable to be executed by the processor device 402 as needed. When executed by the processor device 402, the instructions cause the processor device 402 to perform the associated tasks, processes, and operations defined by the instructions. Of course, the memory/storage device 404 may also include instructions associated with a file system of the host device 400 and instructions associated with other applications or programs. Moreover, the memory/storage device 404 can serve as a data storage unit for the host device 400. For example, the memory/storage device 404 can provide storage for: source content such as raw video program files; video segments; client device information, configuration data, etc.; network information such as status data, configuration data, etc.; and user profile data.

The display element 406 may be integrated with the device 400 or communicatively coupled to the device 400 as a peripheral or accessory component. The shape, size, resolution, and technology of the display element 406 is appropriate to the particular implementation of the device 400. In certain embodiments, the display element 406 is realized as a touchscreen.

The communication interface 408 represents the hardware, software, and processing logic that enables the device 400 to support data communication with other devices. In practice, the communication interface 408 can be suitably configured to support wireless and/or wired data communication protocols as appropriate to the particular embodiment. For example, if the device 400 is a smartphone, then the communication interface 408 can be designed to support a cellular communication protocol, a short-range wireless protocol (such as the BLUETOOTH communication protocol), and a WLAN protocol. As another example, if the device 400 is a desktop or laptop computer, then the communication interface can be designed to support the BLUETOOTH communication protocol, a WLAN protocol, and a LAN communication protocol (e.g., Ethernet).

The I/O devices 410 enable the user of the device 400 to interact with the device 400 as needed. In practice, the I/O devices 410 may include, without limitation: a speaker, an audio transducer, or other audio feedback component; a haptic feedback device; a microphone; a mouse or other pointing device; a touchscreen or touchpad device; a keyboard; a joystick; or any conventional peripheral device. In this context, a touchscreen display can be categorized as an I/O device 410.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A method of processing and delivering video content, the method comprising:
maintaining, at a computer-based server system, a raw version of a video program;
before receiving any request to stream the video program from the server system to a client presentation device, performing a prefetching routine on the raw version of the video program, wherein the prefetching routine transcodes and segments a leading portion of the raw version of the video program into a plurality of sets of prefetched video segments, each set of prefetched video segments associated with a different combination of display resolution and video file format;
before receiving any request to stream the video program from the server system to the client presentation device, storing the plurality of sets of prefetched video segments in cache memory of the server system;
receiving, at the server system, a request to stream the video program from the server system to the client presentation device;
selecting, in response to receiving the request, only one of the plurality of sets of prefetched video segments;
streaming the selected set of prefetched video segments from the cache memory; and
in response to receiving the request, performing the prefetching routine on the raw version of the video program to transcode and segment a future portion of the raw version of the video program only in accordance with the combination of display resolution and video file format corresponding to the selected set of prefetched video segments, resulting in additional prefetched video segments.

2. The method of claim 1, wherein the future portion of the raw version of the video program is transcoded and segmented during streaming of the prefetched video segments from the cache memory.

3. The method of claim 1, further comprising the step of storing the additional prefetched video segments in the cache memory.

4. The method of claim 3, further comprising the step of streaming the additional prefetched video segments from the cache memory.

5-6. (canceled)

7. The method of claim 1, wherein the request to stream the video program includes a display resolution identifier, and wherein the selecting step selects one of the plurality of sets of prefetched video segments based on the display resolution identifier.

8-9. (canceled)

10. A computer-implemented server system comprising:
a processor device; and
a non-transitory computer readable medium operatively associated with the processor device, the computer readable medium comprising executable instructions configurable to cause the processor device to perform a method of processing and delivering video content, the method comprising the steps of:
maintaining, at the server system, a raw version of a video program;
before receiving any request to stream the video program from the server system to a client presentation device, performing a prefetching routine on the raw version of the video program, wherein the prefetching routine transcodes and segments a leading portion of the raw version of the video program into a plurality of sets of prefetched video segments, each set of prefetched video segments associated with a different combination of display resolution and video file format;
before receiving any request to stream the video program from the server system to the client presentation device, storing the plurality of sets of prefetched video segments in cache memory of the server system;
receiving, at the server system, a request to stream the video program from the server system to the client presentation device;
selecting, in response to receiving the request, only one of the plurality of sets of prefetched video segments;
streaming the selected set of prefetched video segments from the cache memory; and
in response to receiving the request, performing the prefetching routine on the raw version of the video program to transcode and segment a future portion of the raw version of the video program only in accordance with the combination of display resolution and video file format corresponding to the selected set of prefetched video segments, resulting in additional prefetched video segments.

11. The server system of claim 10, wherein the method executed by the server system further comprises the step of storing the additional prefetched video segments in the cache memory.

12-20. (canceled)

21. The method of claim 1, wherein the selecting step selects one of the plurality of sets of prefetched video segments based on characteristics of the client presentation device.

22. The server system of claim 10, wherein the request to stream the video program includes a display resolution identifier, and wherein the selecting step selects one of the plurality of sets of prefetched video segments based on the display resolution identifier.

23. The server system of claim 10, wherein the selecting step selects one of the plurality of sets of prefetched video segments based on characteristics of the client presentation device.
